(19) United States
(12) Patent Application Publication
(10) Pub. No.: US 2015/0314316 A1
(43) Pub. Date: Nov. 5, 2015

(54) DIP TUBE ASSEMBLIES AND METHODS OF MANUFACTURING THE SAME

(71) Applicant: ADVANCED TECHNOLOGY MATERIALS, INC., Danbury,, CT (US)

(72) Inventors: Matt KUSZ, Lincoln, NE (US); Richard D. CHISM, Round Rock, TX (US); Bruce MUSOLF, Eagan, MN (US)

(73) Assignee: ADVANCE TECHNOLOGY MATERIALS, INC, Billerica, MA (US)

(21) Appl. No.: 14/440,013

(22) PCT Filed: Oct. 30, 2013
(86) PCT No.: PCT/US13/67487

§ 371 Date: Apr. 30, 2015

Related U.S. Application Data
(60) Provisional application No. 61/721,838, filed on Nov. 2, 2012.
(60) Provisional application No. 61/831,202, filed on Jun. 5, 2013.

(51) Int. Cl. B05B 15/00; B05B 11/04

(52) U.S. Cl. CPC B05B 15/005; B05B 11/048

(57) ABSTRACT

A dip tube assembly having a tubular body portion and a coupler overmolded to a first end of the tubular body portion, the coupler configured for removable coupling with the mouth of a container storing contents therein. Also disclosed are a method of making the overmolded dip tube assembly and a container system including the overmolded dip tube assembly. In some embodiments, the tubular body portion and/or the coupler may include retention features molded into a surface thereof at an overmold interface between the tubular body portion and the coupler.

### FIELD OF THE INVENTION

The present disclosure relates to improved dip tube assemblies and methods for manufacturing the same.

### BACKGROUND OF THE INVENTION

Container systems may be used in many industries for storing, shipping and/or dispensing materials of any viscosity. For example, numerous manufacturing processes require the use of ultrapure liquids, such as acids, solvents, bases, photoresists, slurries, cleaning formulations, dopants, inorganic, organic, metalorganic and biological solutions, pharmaceuticals, and radioactive chemicals. Further many other industries use container systems for a variety of applications, for example the food industry, pharmaceutical industry, cosmetic industry, etc. Typically, a shipping and dispensing system will include a container of some kind, and/or a liner, a cap that may be used to seal and protect the contents of the storage system when the contents are not being dispensed, and a connector that may be used to dispense the contents from the container. The liner and or container may include a fitment that allows caps, connectors, or other coupling devices to be coupled with the container system. Some systems further include a dip tube or a dip tube assembly that may assist in dispensing the contents of the container.

Conventional dip tube assemblies may include a relatively long and slender tubular portion that may be generally cylindrically shaped having a given diameter and a given length, often depending on the intended use. The tubular portion may be configured for placement so as to extend into an interior cavity of a liner or other container. To assist in proper placement of the tubular portion, the tubular portion may be configured to cooperate with a coupler portion that is shaped and configured to substantially fit into, or adjacent to, the mouth of the liner or other container, such as by fitting into or adjacent to, or coupling with, a fitment portion of the liner or other container, so as to generally fixedly couple or connect the tubular portion with the liner or other container. The tubular portion and coupler portion may be, and often are, separate stand-alone parts. For example, the tubular portion may often by a standard tube and the coupler portion may be a particularly custom part designed to permit coupling between the standard tube and a custom dispense container. In this regard, the coupler portion may often be configured with a tubular receiving cavity designed to receive and accommodate liquid-tight insertion of the tubular portion and an exterior designed to substantially fit into, or adjacent to, the mouth or fitment portion of a particular model container or other custom container.

One such known dip tube assembly includes a coupler portion having a receiving cavity that has a generally circular opening and a diameter cross-section that slightly tapers or narrows moving further into the receiving cavity, away from the entrance thereof, so as to form a conical frustrum. The tubular portion of the dip tube assembly may be inserted into the opening of the conical frustrum shaped receiving cavity of the coupler in friction-fit or press-fit style, thereby snuggly holding the tubular portion in generally fixed attachment with the coupler portion for sealability.

Another known dip tube assembly includes a coupler portion that is configured at one end for insertion into a top end of the tubular portion, in somewhat reverse fashion to the previously described embodiment. In order to insert the end of the coupler portion into the top end of the tubular portion, the top end of the tubular portion is first heated on a mandrel to widen the opening, thereby permitting insertion of the coupler end. When cooled, the coupler and tubular portion are thereby coupled via interference fit.

In such embodiments, the connection means between the coupler and the tubular portion, however, may not be entirely suitable. Indeed, the above friction-fit methods may not provide the required amount of seal between the coupler and tubular portion for all desired uses. Furthermore, methods that include heating the top end of the tubular portion prior to inserting the coupler therein may be relatively expensive and time-consuming and can produce generally inconsistent results. Additionally, because dip tube assemblies can, in some cases, be relatively expensive, often the consumers may attempt to clean and reuse some or all of the dip tube assembly components. Reuse of a dip tube assembly inherently increases the risk of introducing contaminated particles or chemicals into the contents of a container. The above disclosed embodiments do not provide enough discouragement for reuse.

Accordingly, there is a need for dip tube assemblies that overcome the disadvantages of conventional dip tube assemblies in one or more ways. That is, there is a need for improved dip tube assemblies and methods for manufacturing the same.

### BRIEF SUMMARY OF THE INVENTION

The present disclosure, in one embodiment, relates to a dip tube assembly having a tubular body portion and a coupler overmolded to a first end of the tubular body portion, the coupler configured for removable coupling with the mouth of a container storing contents therein. The present disclosure further relates to a method of making the overmolded dip tube assembly and a container system including the overmolded dip tube assembly. In additional embodiments, the tubular body portion and/or the coupler may include retention features molded into a surface thereof at an overmold interface between the tubular body portion and the coupler. In one particular embodiment, one of the tubular body portion or the coupler includes a groove molded into a surface thereof at the overmold interface and the other of the tubular body portion and the coupler comprises a mating rib molded into a surface thereof at the overmold interface.

The present disclosure, in another embodiment, relates to a dip tube assembly having a tubular body portion with first and second ends, and a coupler having one or more walls defining an interior passageway for receiving the tubular body portion therethrough, with at least one of the walls including a relief area providing flexibility to the wall to permit the tubular body portion to pass through. More particularly, in one embodiment, the tubular body portion is configured for insertion, by the second end first, into the interior passageway, and the coupler is configured to permit the tubular body portion to be pulled through the interior passageway until the second end exits the interior passageway and the first end is left substantially surrounded by the coupler. In additional embodiments, at least a portion of the interior passageway is shaped as a substantially conical frustrum to improve gripability of the coupler. In an example embodiment, the relief area is an elongated slit in the wall of the coupler.

The present disclosure, in still a further embodiment, relates to a dip tube assembly having a coupler and a tubular body portion, with the coupler configured for removable coupling with the mouth of a container storing contents therein and the tubular body portion configured to extend from the coupler into an interior of the container. Advantageously, the coupler and the tubular body portion are molded as a unitary component. The unitary dip tube assembly may have a coupling pull of force between the tubular body portion and the coupler of greater than 100 lbf, greater than 140 lbf, or even greater than 160 lbf. In one embodiment, an inner passage way of the tubular body portion may have a diameter of about 0.250 inches which tapers, at an end within the coupler, to a diameter of about 0.230 inches.

The present disclosure, in yet another embodiment, relates to a method of making a dip tube assembly and includes overmolding a coupler to a first end of an elongated tubular body, the coupler configured for removable coupling with the mouth of a container storing contents therein with the tubular body portion extending into an interior of the container. In additional embodiments, the elongated tubular body and/or the coupler may include retention features molded into a surface thereof at an overmold interface between the tubular body portion and the coupler.

The present disclosure, in another embodiment, relates to a container assembly having a rigid overpack, a collapsible liner provided within the overpack and having a fitment defining a mouth to the collapsible liner, and a dip tube assembly. The dip tube assembly may include a tubular body portion and a coupler overmolded to a first end of the tubular body portion, the coupler removably coupled with the fitment of the collapsible liner with the tubular body portion extending into an interior of the collapsible liner. The coupler may further include a circumferential notch having an O-ring positioned therein for liquid-tight sealing with the fitment. The coupler, in some embodiments, may include a notch permitting headspace gas removal. In still further embodiments, at least one of the tubular body portion and coupler may include retention features molded into a surface thereof at an overmold interface between the tubular body portion and the coupler.

The present disclosure, in still a further embodiment, relates to a dip tube assembly having a tubular body portion with a first end and a second end, and a coupler having one or more walls defining an interior passageway for receiving the tubular body portion therethrough, wherein at least a portion of the interior passageway defines a substantially conical frustrum.

While multiple embodiments are disclosed, still other embodiments of the present disclosure will become apparent to those skilled in the art from the following detailed description, which shows and describes illustrative embodiments of the disclosure. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the disclosure will be better understood from the following description taken in conjunction with the accompanying Figures, in which:

FIG. 1 is a front view of a dip tube assembly in accordance with one embodiment of the present disclosure.

FIG. 2 is a cross-sectional view of a container and/or dispensing system including a dip tube assembly according to one embodiment of the present disclosure.

FIG. 3 is a cross-sectional view of a dip tube assembly according to one embodiment of the present disclosure.

FIG. 4 is a cross-sectional view of a dip tube assembly according to another embodiment of the present disclosure.

FIG. 5A is a front view of a dip tube assembly according to still another embodiment of the present disclosure.

FIG. 5B is a cross-sectional view of the dip tube assembly of FIG. 5A.

FIG. 6 is a cross-sectional view of a dip tube assembly according to yet another embodiment of the present disclosure.

FIG. 7 is a cross-sectional view of a dip tube assembly according to a further embodiment of the present disclosure.

FIG. 8 is a cross-sectional view of a dip tube assembly according to another embodiment of the present disclosure.

FIG. 9 is a cross-sectional perspective view of an injection molding apparatus for manufacturing an overmolded dip tube assembly according to the embodiment of FIG. 6.

FIG. 10 is a cross-sectional view of a unitary dip tube assembly, in accordance with embodiments of the present disclosure.

FIG. 11 is a graph illustrating the coupling pull off force for conventional dip tube assemblies against unitary dip tube assemblies according to the present disclosure.

FIG. 12 is a graph illustrating the increased flow of unitary dip tube assemblies according to the present disclosure.

### DETAILED DESCRIPTION

The present disclosure relates to novel and advantageous dip tube systems or assemblies for use with container systems, such as but not limited to, liner-based storage and dispensing systems as will be noted herein.

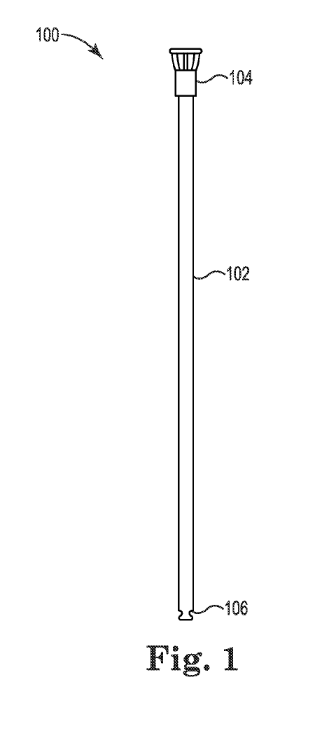

Generally, as illustrated in FIG. 1, a dip tube assembly 100 according to the present disclosure may include a tubular portion 102 and a coupler portion 104. Tubular portion 102 may be generally cylindrically shaped or straw-like with an interior passageway extending generally from one end to the other, as will be understood by those skilled in the art. The tubular portion 102 may be substantially long and slender; however, it is understood that the tubular portion 102 may have any suitable or desirable length and any suitable or desirable exterior diameter as well as interior passageway diameter. Often the length and diameters of the tubular portion may depend on the intended application and desired dispense characteristics. In some embodiments, a bottom end, or an end opposite the location of the coupler portion 104, may include one or more side wall openings 106. Side wall openings may provide improved dispensing of liquid or other material through the dip tube via the tubular portion 102.

The coupler portion 104, as will be described in further detail in various embodiments herein, may be coupled with or integral with the tubular portion 102. The coupler portion 104 may take on various configurations, but is generally configured at one end to cooperate in fluid communication with a top end of the tubular portion 102 and at the other end to substantially fit into, or adjacent to, the mouth of a particular liner or other container, such as by fitting into or adjacent to, or otherwise coupling with, a fitment portion of the liner or container. In this regard, the coupler portion 104 may be configured to cooperate, or fit, with any suitable liner or container, thus permitting flexible use of tubular portion 102 with any particular model container or other custom container. The coupler portion 104 may generally assist in the proper placement of the tubular portion 102 and generally maintains the tubular portion in fixed relationship with the liner or container during dispense of the contents therein. The coupler portion 104 also includes an interior passageway extending generally from one end to the other, and the interior passageway is in fluid communication with the interior passageway of the tubular portion, such that a fluid or other material may flow from a bottom end of the tubular portion, through the tubular portion and the coupler, so as to exit at a top end of the coupler, often being delivered to a dispense connector and subsequent downstream process, as would be understood by those skilled in the art.

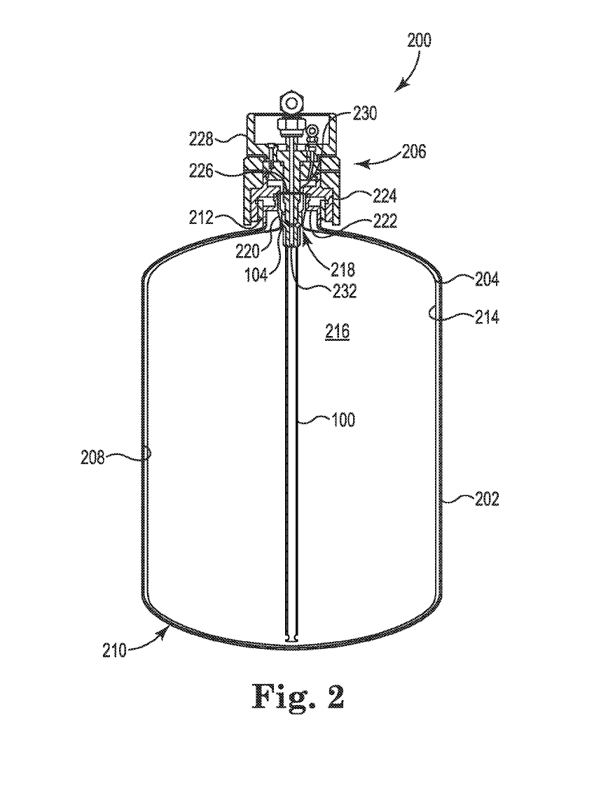

The dip tube assemblies 100 of the present disclosure may be used with any suitable container and/or dispensing system. In some embodiments, dip tube assemblies 100 of the present disclosure may be used with existing container and/or dispensing systems, while in other embodiments, the dip tube assemblies may be specifically configured for compatibility with a custom container and dispensing system. A typical container and/or dispensing system that may be used with dip tube assemblies 100 of the present disclosure is shown in FIG. 2, though it will be understood that the dip tube assemblies of the present disclosure may be used with any suitable container or storage and dispensing system and accordingly contain fewer, more, or different components than those illustrated, for example, in FIG. 2.

As shown in FIG. 2, a container and/or dispensing system 200 may include an overpack 202, a liner 204, one or more closures and/or connectors 206, and a dip tube assembly 100 in accordance with various embodiments of the present disclosure. The overpack 202 may include an overpack wall 208, an interior cavity 210, and a mouth 212. The overpack 202 may be comprised of any suitable material or combination of materials, for example but not limited to, metal materials, or one or more polymers, including plastics, nylons, EVOH, polyesters, polyolefins, or other natural or synthetic polymers. In further embodiments, the overpack 202 may be manufactured using polyethylene terephthalate (PET), polyethylene naphthalate (PEN), poly(butylene 2,6-naphthalate) (PBN), polyethylene (PE), linear low-density polyethylene (LLDPE), low-density polyethylene (LDPE), medium-density polyethylene (MDPE), high-density polyethylene (HDPE), polypropylene (PP), and/or a fluoropolymer, such as but not limited to, polychlorotrifluoroethylene (PCTFE), polytetrafluoroethylene (PTFE), fluorinated ethylene propylene (FEP), and perfluoroalkoxy (PFA). The overpack 202 may be of any suitable shape or configuration, such as, but not limited to, a bottle, a can, a drum, etc.

The liner 204, which may be disposed within the overpack 202. The liner 204 may be configured to comprise any desirable shape that is appealing to the user, and/or assists in the collapse of the liner. The liner 204, in some embodiments, may be dimensioned and shaped to substantially conform to the interior of the overpack 202. In a further embodiment, the liner 204 may have a shape, when inflated or filled, that is different from, but complimentary with, the shape of the overpack 202. The liner 204 may include a liner wall 214, an interior cavity 216, and a mouth 218. The mouth 218 of the liner 204 may include a fitment portion 220. The fitment portion 220 may be, but need not be, made of a different material than the rest of the liner 204 and may be harder, more resilient, and/or less flexible than the rest of the liner. The fitment portion 220 may couple with a one or more components of closures and/or connectors 206, which may be achieved by any suitable means, such as but not limited to, complementary threading, snap-fit or friction-fit means, bayonet means, or any other suitable mechanism or combination of mechanisms for coupling, as will be appreciated by those skilled in the art. In some embodiments, one or more of the closures and/or connectors 206 may couple to, or may also couple to, the mouth 212 of the overpack 202.

In some embodiments, the liner 204 may be a collapsible liner that is substantially flexible, while in other embodiments the liner may be somewhat rigid but still collapsible, e.g., a rigid or substantially rigid collapsible liner. As used herein, the terms “rigid” or “substantially rigid,” in addition to any standard dictionary definitions, are meant to also include the characteristic of an object or material to substantially hold its shape and/or volume when in an environment of a first pressure, but wherein the shape and/or volume may be altered in an environment of increased or decreased pressure. The amount of increased or decreased pressure needed to alter the shape and/or volume of the object or material may depend on the application desired for the material or object and may vary from application to application. In addition, the term “substantially rigid” is meant to include the characteristic of an object or material to substantially hold its shape and/or volume, but upon application of such increased or decreased pressure, tend to give, such as by but not limited to, flexing, bending, etc., rather than breaking.

The liner 204 may be manufactured using any suitable material or combination of materials, such as but not limited to, any of the non-metal materials or combination of materials listed above with respect to the overpack 202. However, the overpack 202 and liner 204 need not be manufactured from the same materials. The liner 204 may have one or more layers and may have any desirable thickness. In one embodiment, for example, a liner 204 may have a thickness of from about 0.05 mm to about 3 mm.

The overpack 202 and liner 204 may each be manufactured using any suitable manufacturing process, such as but not limited to, injection blow molding, injection stretch blow molding, extrusion, welding, etc., and may each be manufactured as a single component or may be a combination of multiple components. In some embodiments, the overpack 202 and liner 204 may be blow molded in a nested fashion, also referred to herein as co-blow molded. Examples of liner-based systems and methods utilizing co-blow molding techniques have been described in greater detail in International PCT Appl. No. PCT/US11/55560, titled, “Nested Blow Molded Liner and Overpack and Methods of Making Same,” filed Oct. 10, 2011, which is hereby incorporated herein by reference in its entirety. In some embodiments a liner may be blow molded into an already formed overpack, whereby the overpack may function as the mold for the liner, and may be referred to herein as “dual blow molding,” which is described in further detail below. In such embodiments, the overpack may be manufactured by any suitable process.

Example connectors 206 may include but are not limited to, a liner retaining ring 222 for maintaining the liner 204 in proper placement with respect to the overpack 202, a cap 224 or other closure, which may also include a break seal 226, for sealing the contents in the liner 204, and a dispense connector 228, having a probe 230 for operably coupling the dispense connector in fluid communication with the interior passageway 232 of a coupler portion 104 of a dip tube assembly 100 in accordance with various embodiments of the present disclosure.

Further examples and embodiments of the type of liners, overpacks, and connectors that may be used are disclosed in more detail in: International PCT Appl. No. PCT/US11/55558, titled, “Substantially Rigid Collapsible Liner, Container and/or Liner for Replacing Glass Bottles, and Enhanced Flexible Liners,” filed Oct. 10, 2011; International PCT Appl. No. PCT/US11/55560, titled, “Nested Blow Molded Liner and Overpack and Methods of Making Same,” filed Oct. 10, 2011; International PCT Appl. No. PCT/US11/64141, titled “Generally Cylindrically-Shaped Liner for Use in Pressure Dispense Systems and Methods of Manufacturing the Same,” filed Dec. 9, 2011; U.S. Prov. Appl. No. 61/703,996, titled “Liner-Based Shipping and Dispensing Systems,” filed Sep. 21, 2012; U.S. Prov. Appl. No. 61/468,832, titled “Liner-Based Dispenser,” filed Mar. 29, 2011 and related International PCT Appln. No. PCT/US2011/061764, filed Nov. 22, 2011; U.S. Prov. Appl. No. 61/525,540, titled “Liner-Based Dispensing Systems,” filed Aug. 19, 2011 and related International PCT Appln. No. PCT/US2011/061771, filed Nov. 22, 2011; U.S. patent application Ser. No. 13/149,844, titled “Fluid Storage and Dispensing Systems and Processes,” filed May 31, 2000 U.S. patent application Ser. No. 11/915,996, titled “Fluid Storage and Dispensing Systems and Processes,” filed Jun. 5, 2006; International PCT Appl. No. PCT/US10/51786, titled “Material Storage and Dispensing System and Method With Degassing Assembly,” filed Oct. 7, 2010; International PCT Appl. No. PCT/US10/41629; U.S. Pat. No. 7,335,721; U.S. patent application Ser. No. 11/912,629; U.S. patent application Ser. No. 12/302,287; International PCT Appl. No. PCT/US08/85264; U.S. patent application Ser. No. 12/745,605, filed Feb. 15, 2011; U.S. Prov. Appln. No. 61/605,011, titled “Liner-Based Shipping and Dispensing System,” filed Feb. 29, 2012; and U.S. Prov. Appln. No. 61/561,493, titled “Closure/Connectors for Liner-Based Shipping and Dispensing Containers,” filed Nov. 18, 2011, each of which is hereby incorporated by reference herein in its entirety. The overpack 202 and liner 204 may include any of the embodiments, features, and/or enhancements disclosed in any of the above noted applications, including, but not limited to, flexible, rigid collapsible, 2-dimensional, 3-dimensional, welded, molded, gusseted, and/or non-gusseted liners, and/or liners that contain folds and/or liners that comprise methods for limiting or eliminating choke-off and liners sold under the brand name NOWpak® by ATMI, Inc. for example. Various features of dispensing systems disclosed in embodiments described herein may be used in combination with one or more other features described with regard to other embodiments.

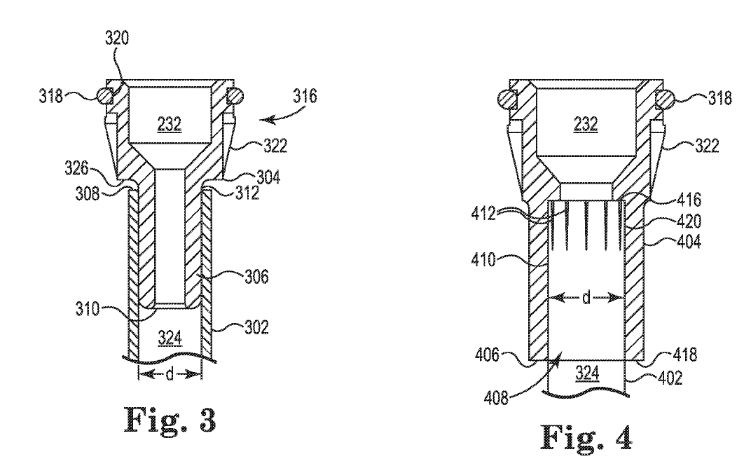

FIG. 3 illustrates one embodiment of a dip tube assembly 100 according to the present disclosure. As discussed above, the dip tube assembly comprises a tubular portion 302 and a coupler portion 304. Unlike conventional dip tube assemblies, which as described above, require the tubular portion of the dip tube to be inserted into a receiving cavity of the coupler in friction-fit or press-fit style, in the embodiment illustrated in FIG. 3, the coupler portion 304 may be configured at one end 306 for insertion into a top end 308 of the tubular portion 302, in a somewhat reverse fashion than that of conventional dip tube assemblies. While only slightly visible in FIG. 3, in some embodiments, the exterior of end 306 of the coupler portion 304, which is configured for insertion into end 308 of the tubular portion 302, may comprise a coupler wall with a generally circular cross-section, at least the external diameter, d, of which slightly increases or widens as you move along end 306 from the bottom 310 of end 306 to the top 312, thereby forming a substantially conical frustrum exterior at end 306. In this regard, the narrow end 310 of the conical frustrum may be designed for relatively easy insertion into end 308 of the tubular portion 302, with the wider end 312 following thereafter so as to create an increased friction-fit or press-fit interface 314 with the tubular portion, which snuggly and securely holds the tubular portion in generally fixed and liquid-tight attachment with the coupler portion for sealability. The rate at which the coupler wall increases or widens in diameter can be any suitable rate, and often may be selected based on the desired fit between the tubular portion and the coupler portion. Likewise, while discussed mainly with respect to a widening of the external diameter, d, from the bottom 310 to the top 312 of end 306, the widening of the external diameter could be reversed so as to start at the top 312 of end 306 and widen toward the bottom 310.

The coupler portion 302 may include a stop ledge 326 extending radially from the coupler portion and defining a stopping point whereat a top end 308 of the tubular portion may abut upon insertion of the coupler portion into the tubular portion to a desired depth. In this regard, the tubular portion 302 may be precluded from extending too far over the coupler portion 304.

As will be substantially applicable throughout each embodiment disclosed herein, and as generally mentioned above but illustrated more visibly in FIGS. 3-8, the coupler portion may include a top end 316 that while it may take on various configurations, is generally configured to substantially fit into, or adjacent to, the mouth of a particular liner or other container, such as but not limited to mouth 218 or fitment portion 220 of liner 204. In this regard, the coupler portion may be configured to cooperate, or fit, with any suitable liner or container, thus permitting flexible use of tubular portion with any particular model container or other custom container. If desired, the coupler portion may be configured for even more secure attachment with the mouth 218 or fitment portion 220 of the liner 204, by any additional securing means, such as but not limited to, complementary threading, snap-fit or friction-fit means, bayonet means, or any other suitable mechanism or combination of mechanisms for coupling, as will be appreciated by those skilled in the art. In some embodiments, the top end 316 may be configured for liquid-tight seal with an interior of the mouth 218 or fitment portion 220 of the liner 204, as illustrated for example in FIG. 2. In further embodiments, the top end 316 may be provided with a sealing member, such as but not limited to a conventional O-ring 318, to assist in providing a liquid-tight seal with an interior of the mouth 218, fitment portion 220, or one or more other components of a container and/or dispensing system, such as the retaining ring or other components of the closures and/or connectors 206, for example. In such embodiments, the top end 316 of the coupler portion may include a circumferential notch 320 sized and shaped to accommodate the O-ring 318. In addition, the top end of the coupler portion may include one or more notches or other features 322 for allowing headspace gas to escape or for headspace gas to be removed. Generally, the expression “headspace,” as used herein, may refer to the gas space in a liner or other container that may rise to the top of the liner/container, above the contents stored therein. If all, or substantially all, of the headspace gas is removed, then generally the only remaining sources of gas bubbles, if any, would be from any folds in the liner. The notches 322 may have any suitable size and shape and may be present in any suitable number, or may not be present at all, in some embodiments.

As also will be substantially similar throughout each embodiment disclosed herein, and as generally mentioned above but illustrated more visibly in FIGS. 3-8, for example, the coupler portion may include an internal passageway 232 in fluid communication with the interior passageway 324 of the tubular portion. The internal passageway 232 thereby provides a fluid channel to the contents of the liner 204 or other container via the tubular portion for external access of the contents such as by, but not limited to, dispense connector 228.

FIG. 4 illustrates another embodiment of a dip tube assembly 100 of the present disclosure. As discussed above, the dip tube assembly comprises a tubular portion 402 and a coupler portion 404. Similar to conventional dip tube assemblies, the coupler portion 404 may include a bottom end 406 having a receiving cavity 408 that is configured to receive and accommodate a top end 410 of the tubular portion 402. The tubular portion 402 may be inserted into the receiving cavity 408 to a depth up to a stop ledge 416, protruding centrally toward an interior of the coupler portion, providing a stopping point for insertion of the tubular portion. In this regard, the tubular portion 402 may be precluded from extending too far into, or even entirely through, the coupler portion 404. The receiving cavity 408, which is configured for receiving a top end 410 of the tubular portion 402, may comprise a coupler wall with a generally circular cross-section. The interior of the coupler wall may include one or more retention features 412 for improved connection and retention between the tubular portion 402 and the coupler portion 404 upon insertion of the top end 410 of the tubular portion into the receiving cavity 408 of the coupler portion. The retention features 412 may be present in any suitable number, configuration, and/or geometry. For example, in some embodiments, the retention features 412 may comprise linear slits or protrusions in the coupler wall, whereby the slits or protrusions may be oriented horizontally, vertically, or in any other suitable orientation and in any suitable length and/or width. In other cases, the one or more retention features 412 may comprise other type of protrusions, indentations, or combination thereof. The protrusions and/or indentations may have any suitable size or geometry, such as but not limited to, circular, triangular, rectangular, octagonal, or any other desired and/or useful shape. Further yet, each protrusion and/or indentation need not be configured identical to the others. In some embodiments, for example, the interior of the coupler wall may include a plurality of bumps, scales, or projections, which may each have any appropriate size, as may be desired for the intended results. The retention features 412 may be spaced any suitable distance from one another.

In additional embodiments, the interior of receiving cavity 408 of the coupler portion 404 may comprise a coupler wall with a generally circular cross-section, at least the interior diameter, d, of which slightly decreases or narrows as you move along end 406 from the bottom 418 of end 406 toward a top 420, thereby forming a substantially conical frustrum interior of the receiving cavity 408. As described above, the top end 410 of the tubular portion 402 may be inserted into the conical frustrum shaped interior of the receiving cavity 408 in friction-fit or press-fit style, thereby providing additional grip for securely holding the tubular portion in generally fixed attachment with the coupler portion for sealability. The rate at which the coupler wall decreases or narrows in diameter can be any suitable rate, and often may be selected based on the desired fit between the tubular portion and the coupler portion. Likewise, while discussed mainly with respect to a narrowing of the internal diameter, d, from the bottom 418 to the top 420 of end 406, the narrowing of the internal diameter could be reversed so as to start at or near the top 420 of end 406 and narrow toward the bottom 418.

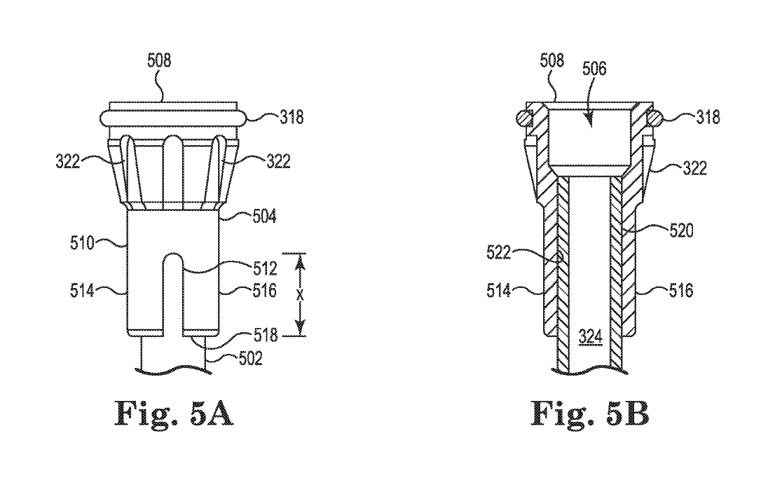

FIGS. 5A and B illustrate another embodiment of a dip tube assembly 100 of the present disclosure. As discussed above, the dip tube assembly comprises a tubular portion 502 and a coupler portion 504. As illustrated more particularly in FIG. 5B, the coupler portion 504 may include an interior passageway 506, without a stop ledge as described above, permitting insertion of the tubular portion 502 from a top end 508 of the coupler portion. In this regard, the tubular portion 502 may be coupled with the coupler portion 504 by inserting the tubular portion, bottom end first, into the interior passageway 506 via the top end 508 of the coupler portion, and subsequently pulling or pushing the tubular portion through the interior passageway until the tubular portion establishes a secure connection with the coupler portion, and is substantially in a position as shown in FIG. 5B with a top end 520 of the tubular portion secured within the coupler portion and the bottom end of the tubular portion extending downward from the coupler portion. In some embodiments, in order to accommodate insertion of the tubular portion 502 from a top end 508 of the coupler portion 504, and to ease the effort required to safely pull or push the tubular portion down through the interior passageway 506, a bottom wall portion 510 of the coupler portion 504 may include one or more relief areas 512, which permit the bottom wall portion 510 to flex as the tubular portion passes through the interior passageway. The relief areas 512, in one embodiment as shown in FIG. 5A, may include areas that are cut out or removed from the bottom wall portion 510, dividing the bottom wall portion into two or more flexible wall portions 514, 516. The flexible wall portions 514, 516 may be configured so as to flex enough to permit tubular portion 502 to pass through, but not so much as to lose a liquid-tight seal between the bottom wall portion and the tubular portion. In one embodiment, the relief areas 512 may be configured as elongated slits extending from a bottom end 518 of the coupler portion 504, to a distance, x, toward the top end of the coupler portion. The width of the slits as well as the distance, x, selected may vary for different embodiments, but can be any suitable width and distance, as desired or required to permit tubular portion 502 to pass through the interior passageway, as described above, but maintain the tubular portion in liquid-tight connection with the coupler portion. While elongated slits are illustrated in FIG. 5A, the relief areas may be configured in any suitable size, shape, and configuration. For example, the one or more relief areas 512 may be horizontally aligned, vertically aligned, or may have any suitable orientation therebetween.

In additional embodiments, and slightly visible in FIG. 5B, the interior 522 of bottom wall portion 510 or flexible wall portions 514, 516 may define a substantially conical frustrum interior, as described in previous embodiments, thereby providing additional grip for securely holding the tubular portion 502 in generally fixed attachment with the coupler portion 504 for sealability.

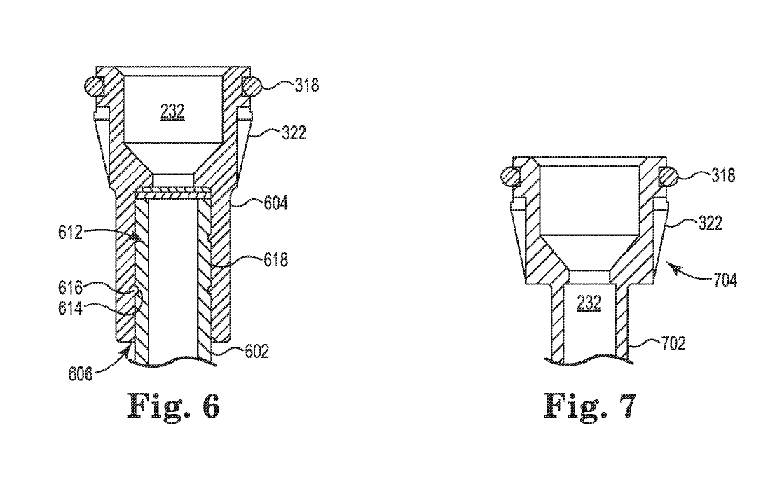

FIG. 6 illustrates another embodiment of a dip tube assembly 100 of the present disclosure. As discussed above, the dip tube assembly comprises a tubular portion 602 and a coupler portion 604. Unlike conventional dip tube assemblies, however, the coupler portion 604 of FIG. 6 may be molded over, or what is commonly referred to as overmolded to, the tubular portion 602, thereby creating a generally conforming coupling interface 618 between the exterior of the tubular portion and the interior receiving cavity 606 of the coupler portion. Specifically, a pre-molded tubular portion 602 may be reinserted to a mold for the coupler portion 604, so that one or more new layers of plastic material, for example, may be formed around the exterior of one end of the tubular portion in the shape of the coupler portion. Such an overmolding process can result in a substantially unitary dip tube assembly, which advantageously increases the coupling interface 618 between tubular portion and the coupler portion, providing increased performance and reduced or eliminated leakage of the dip tube assembly.

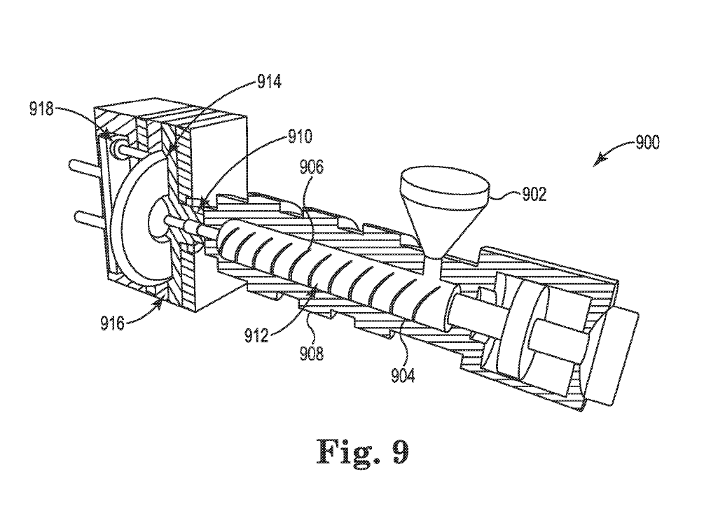

More specifically, in one embodiment for overmolding a dip tube assembly, the process of overmolding may comprise what will be referred generally herein as three stages and may utilize an injection molding apparatus 900 similar to that illustrated in FIG. 9. A first stage of the overmolding process may comprise heating and melting of a polymer resin, such as any of the natural or synthetic polymers listed in further detail below. In one embodiment, for example only, the polymer resin may be a high-density polyethylene (HDPE) resin. In this stage of the overmolding process, the polymer resin pellets may be provided at a hopper or receiver 902 and fed into a barrel cavity 904. The barrel cavity 904 may include a reciprocating screw 906. The barrel cavity 904 may be heated by any suitable means, including but not limited to, by electric heater bands 908 adjacent to or operably coupled with the barrel cavity. The reciprocating screw 906 may rotate, as will be appreciated by those skilled in the art, to move the polymer resin pellets, as they are melting, forward in the barrel cavity 904 toward a nozzle 910. Generally, the desired result is for the melting polymer resin pellets to form a homogeneous melt 912 of the polymer by the time the resin pellets get to the forward end of the barrel cavity 904 and/or to the nozzle 910. A desired melt temperature for the pellets to form such a homogenous melt may be determined, at least in part, by the resin/plastic utilized. In one embodiment, with reference to HDPE pellets, for example, the melt temperature may be selected in the range of from about 380° F. to about 500° F. In one embodiment, the heater bands 908, or other heating means, may be suitable to heat the plastic to a desired or specified point, and the shearing forces generated between the reciprocating screw 906 and the barrel cavity 904 may assist in keeping the temperature of the homogenous melt uniform.

In a second stage of the overmolding process, at the forward end of the barrel cavity 904, the melted plastic 912 may be injected into a dip tube mold cavity 914 of a mold 916 through the nozzle 910. Specifically, in one embodiment, the melted plastic 912 may be provided to the mold through a sprue bushing, then into a runner system, and then through a gate into the dip tube mold cavity 914. Prior to injecting the melted plastic 912 into the dip tube mold cavity 914, a press operator or a mechanized component may place an end of an extruded plastic tube, such as tubular portion 602, into the mold cavity. When the melted plastic 912 is injected into the dip tube mold cavity 914, it may flow around and about the inserted end of the extruded plastic tube. When this happens, the outer skin of the extruded tube may also melt slightly, and the melted plastic 912 injected into the dip tube mold cavity 914 and the extruded tube may securely bond together, thereby forming a unitary part. As, or after, the melted plastic 912 is injected into the dip tube mold cavity 914, a pressure may be applied to the melted plastic in order to pack out the entire dip tube mold cavity. The dip tube mold cavity 914 may be maintained in this pressurized state until the plastic at the gate cools enough, or “freezes off,” which will prevent any additional plastic from entering or leaving the cavity through the gate.

A third stage of the overmolding process may include cooling of the mold and ejection of the resulting overmolded dip tube assembly. The mold 916 may be cooled by any suitable means, including but not limited to, by the use of water. In one embodiment, the mold 916 may be designed with water channels cut into the mold material, which may often be steel or the like. The channels may be designed so they run very near the mold cavity surface. As water runs through the designed channels, the water may remove the heat from the mold cavity. With time, this helps solidify the overmolded dip tube assembly until it is rigid enough to be ejected from the mold 916. In one embodiment, the mold 916 may include one or more ejector pins 918 that may be activated to push the overmolded dip tube out of the dip tube mold cavity 914 after the mold is opened. Cooling times and ejection means needed, if any, may be determined by a variety of aspects of the process, including but not limited to, the dip tube assembly geometry and wall thicknesses. The completed dip tube assembly, such as that illustrated in FIG. 6, may be clipped from the runner at the gate and sent on to further processing, such as but not limited to, packaging. A new extruded tube may then be inserted into the dip tube mold cavity 914 and the overmolding process repeated.

In one particular embodiment, an HDPE polymer resin is melted in the range of about 420° F. to 450° F., and the dip tube mold cavity is packed using pressure up to about 1100 PSI. The mold may be cooled for up to about 20 seconds before ejection.

In additional embodiments, one or more sets of notches, ribs, grooves or other retention features 612 may be correspondingly formed into the tubular portion 602 and the coupler portion 604 to enhance the overmolded coupling interface 618 between the exterior of the tubular portion and the interior receiving cavity 606 of the coupler portion. For example, as illustrated in FIG. 6, a horizontally-oriented groove 614 may be provided in the tubular portion 602, and a corresponding horizontally-oriented rib 616 may be provided in the overmolded coupler portion 604. The rib 616 and groove 614 cooperate or interlock in order to maintain the tubular portion in position inside receiving cavity 606 of the coupler portion. Of course, while ribs and grooves are illustrated in FIG. 6, the invention is not so limited, and it is recognized that any number, pattern, and/or geometry of corresponding features may be utilized. Similarly, any utilized features 612, such as the ribs and grooves shown, may be generally vertically disposed, horizontally disposed, or disposed in any other suitable orientation. In yet other embodiments, there may be no retention features 612.

FIG. 7 illustrates another embodiment of a dip tube assembly 100 of the present disclosure. As with the other embodiments, the dip tube assembly comprises a tubular portion 702 and a coupler portion 704. Unlike conventional dip tube assemblies, however, the tubular portion 702 and coupler portion 704 of FIG. 7 may be molded as a single, unitary component or piece. In such embodiments, the molding process may be designed such that the resulting dip tube assembly has the dimensions desired and includes, if desired, any additional surface features or other features. Any suitable molding technique may be used, such as, but not limited to blow molding, injection blow molding, or any other suitable technique.

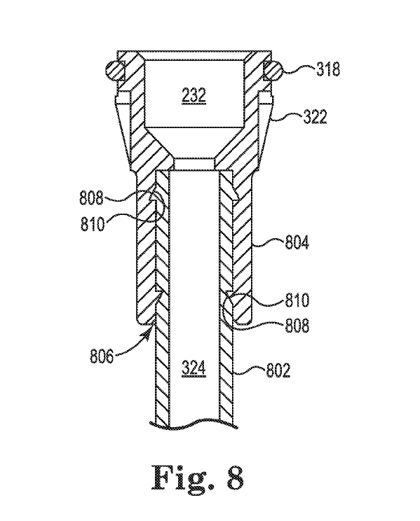

FIG. 8 illustrates yet another embodiment of a dip tube assembly 100 of the present disclosure. As with the other embodiments, the dip tube assembly comprises a tubular portion 802 and a coupler portion 804. The coupler portion 804 may include a tubular receiving cavity 806 at one end thereof designed to receive and accommodate liquid-tight insertion of the tubular portion 802. Tubular portion 802 and coupler portion 804 may be configured for snap-fit or snap-together fit, such that the tubular portion 802 “snaps” into the receiving cavity 806, or the coupler portion 804 “snaps” around the tubular portion. In this regard, the tubular portion 802 and/or the coupler portion 804 may include one or more snap retaining features that permit the tubular portion to be inserted into the receiving cavity and snapped into place for retention therein. In an example embodiment illustrated in FIG. 8, the tubular portion may have one or more notches or grooves 808 on an exterior thereof. The interior of the receiving cavity 806 may be configured with corresponding snap-in protrusions, teeth, or ribs 810. Of course, the interior of the receiving cavity 806 may conversely have one or more notches or grooves 808 while the tubular portion 504 has corresponding snap-in protrusions, teeth, or ribs 510 provided on an exterior thereof, as also illustrated in FIG. 8. Likewise, any other similar snap-features may be utilized, including but not limited to snapping bayonet means or other interlocking means, as will be appreciated by those skilled in the art. Upon insertion of the tubular portion 802 into the receiving cavity 806 to the desired depth, the snap retaining features may lock the tubular portion in place, thus being coupled with the coupler portion. In some embodiments, the snap-fit may be substantially permanent, being undone generally only be breaking the dip tube assembly.

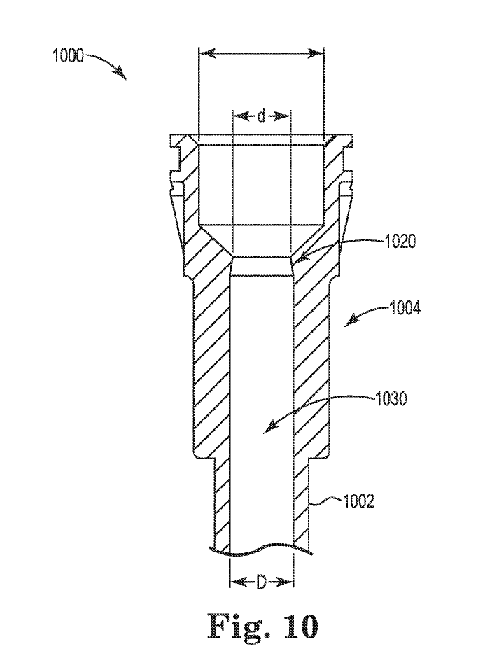

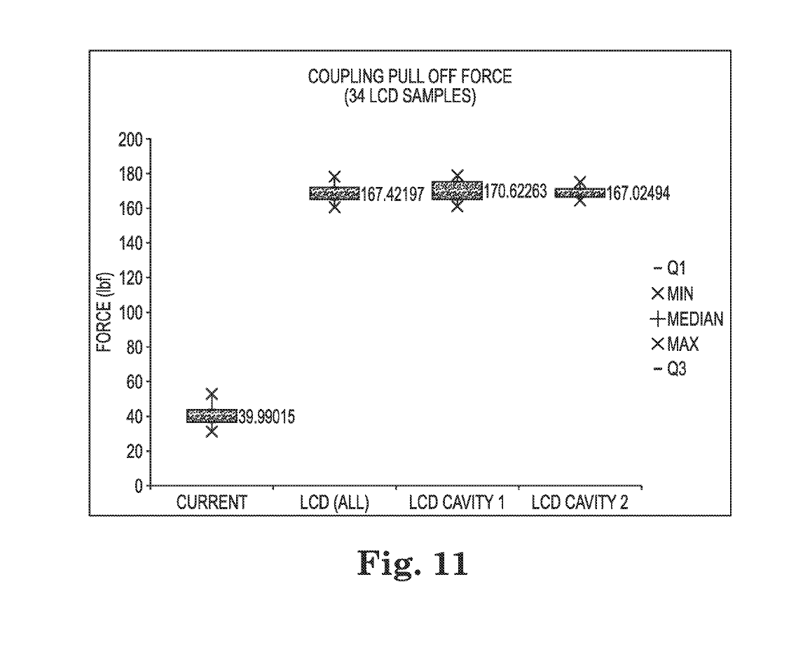

FIG. 10 shows another embodiment of a dip tube assembly 1000. In this embodiment, the tubular portion 1002 and the coupler portion 1004 may be constructed as a single piece. This may advantageously reduce any risk associated with a non-unitary assembly coming apart before, during, or after dispense. Further, a unitary structure may have less risk associated with cracking that may occur at the point where the tubular portion and the coupler portion join in a non-unitary structure. For example, FIG. 11 illustrates the coupling pull off force for conventional two-part (i.e., separate coupler and tubular portions) dip tube assemblies against thirty-six samples of a unitary dip tube assembly according to the present disclosure, such as those illustrated in FIGS. 7 and 10. The coupling pull off force may refer to the amount of force applied that causes separation of the coupler and tubular portions. As illustrated in FIG. 11, the median coupling pull off force for the conventional two-part dip tube assemblies tested was 39.99015 pound-force (lbf), while the median coupling pull off force for the unitary dip tube assemblies tested was over four times greater at 167.42197 lbf. Additionally, because of their unitary nature, the tested dip tube assemblies did not actually “pull off' or totally disengage at the max pull off force. Rather, the tubular portion simply stretched away from the coupler portion.

The unitary assembly 1000 may be manufactured by any suitable process. In some cases, it may be constructed by a welding process, by using a spin, vibration, infrared, sonic, or plate welding process, for example. Other manufacturing processes may additionally, or alternately be used, to form a unitary assembly 1000, such as any other molding process, for example but not limited to, injection molding.

As shown in FIG. 10, in one embodiment, the inner passage way 1030 of the tubular portion may have a diameter D for a given or desired length of the assembly. In one embodiment, diameter D may be substantially uniform and consistent up to or about to the point of the neck 1020 of the inner passage way 1030. At the neck 1020, the inner passageway 1030 may taper inward, thereby reducing the diameter of interior passage way from diameter D to a smaller diameter d in the location of the neck 1020, or at any other desirable location. In some embodiments, the diameter D may be about 0.250 inches, while diameter d may be about 0.230 inches. In other embodiments, however, diameters D and d may have any desired dimension, with diameter d being smaller than diameter D. The neck 1020 may be positioned at any suitable or desired place along the interior passage way of the assembly. There may be one, two, or more necks within the interior passage way, changing the diameter to be either larger or smaller than the diameter of the inner passage way leading into the neck.

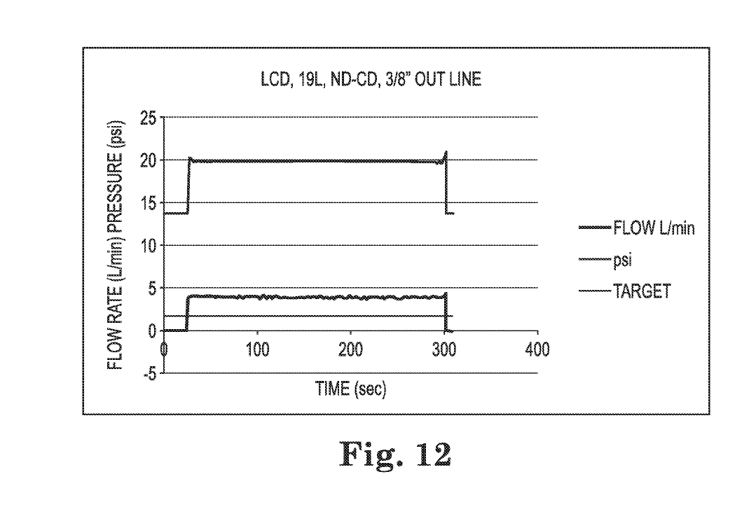

Dip tube assemblies according to the embodiments of the present disclosure illustrated in FIG. 10 can also increase the flow rate therethrough, and ultimately delivered to any connector operably connected therewith. FIG. 12 illustrates the flow rate of a tested unitary dip tube assembly of the present disclosure as tested with a 19 L container using a pressure dispense connector having an inner diameter for the out line of ⅜ inch. The line labeled “psi” in the graph indicates the actual pressure used to cause flow through the dip tube assembly, and the line labeled “target” in the graph indicates the target flow rate typically required for a conventional dip tube assembly at the pressure utilized. As may be seen from the graph, a unitary dip tube assembly of the present disclosure has an increased flow rate of between about 4 to 5 L/min, which is a significant increase over the conventional target flow rate.

In some embodiments of a dip tube assembly, such as any of the dip tube assemblies of the present disclosure, the diameter of the inner passage way of a dip tube assembly may be consistent and uniform from the end of the tubular portion, through the length of the tubular portion, to where the tubular portion joins the coupler portion, and/or through the inner passage way of the coupler portion. The diameter in such cases may be any desired diameter such that the assembly may be securely positioned in a desired liner and/or overpack, and dispense the contents of a liner effectively and/or efficiently. In other embodiments, however, the diameter of the inner passage way may vary. For example, with regard to any of the embodiments disclosed herein, the inner passage way of the tubular portion may have a diameter that is less than, greater than, or equal to the diameter of the inner passage way in some or all parts of the coupler. More generally, any of the embodiments disclosed herein may include one or more inner diameters along the length thereof, including along the tubular portion and/or the coupler portion, that vary in diameter, and all such embodiments are considered within the scope of the present disclosure.

While each feature of the dip tube assembly 100 may not be described with specific reference to every embodiment, it is recognized and considered within the scope of the present application, that any of the features, or combination of features, described with regard to any one of the embodiments shown in FIGS. 3-8 and 10 are applicable to, and may be incorporated into, any of the other embodiments of dip tube assembly 100. For example only, any of the embodiments may use tapering in the interior of the receiving cavity of the coupler portion to increase the amount of grip at the interface between the tubular portion and the coupler portion. Furthermore, any of the embodiments may utilize any of the various retention features disclosed herein.

Any of the dip tube assemblies of the present disclosure, or the various components thereof, such as the tubular portion, coupler portion, or any other additional components, may be manufactured using any suitable manufacturing process, such as but not limited to, injection molding, injection blow molding, injection stretch blow molding, extrusion, etc. In some embodiments, the tubular portion and coupler portion may be manufactured separately, as separate components, while in other embodiments, they may be manufactured as a single, unitary component. Likewise, the tubular portion and/or coupler portion may each separately be comprised of a single unitary element, or they may each be comprised of a combination of multiple elements.

Any of the dip tube assemblies of the present disclosure, or the various components thereof, may be comprised of any suitable material or combination of materials, for example but not limited to, one or more polymers, including plastics, nylons, EVOH, polyesters, polyolefins, or other natural or synthetic polymers. In further embodiments, any of the dip tube assemblies of the present disclosure, or the various components thereof, may be manufactured using polyethylene terephthalate (PET), polyethylene naphthalate (PEN), poly(butylene 2,6-naphthalate) (PBN), polyethylene (PE), linear low-density polyethylene (LLDPE), low-density polyethylene (LDPE), medium-density polyethylene (MDPE), high-density polyethylene (HDPE), polypropylene (PP), and/or a fluoropolymer, such as but not limited to, polychlorotrifluoroethylene (PCTFE), polytetrafluoroethylene (PTFE), fluorinated ethylene propylene (FEP), and perfluoroalkoxy (PFA). Any portion of a dip tube assembly may be comprised of the same or different material(s) than one or more other portions of the dip tube assembly.

The various embodiments of dip tube assemblies for use with container and/or dispensing systems described herein may be utilized with any suitable dispense process. For example, the various embodiments of dip tube assemblies described herein may be utilized in pressure dispense processes, including direct and indirect pressure dispense, pump dispense, and pressure-assisted pump dispense, including various embodiments of inverted dispense methods disclosed in Korean patent registration no. 10-0973707, titled “Apparatus for Supplying Fluid,” which is hereby incorporated by reference herein in its entirety.

Examples of some of the types of materials that may be stored, shipped, and/or dispensed using embodiments of the present disclosure include, but are not limited to: ultrapure liquids, such as acids, solvents, bases, photoresists, slurries, detergents, cleaning formulations, dopants, inorganic, organic, metalorganics, TEOS, and biological solutions, DNA and RNA solvents and reagents, pharmaceuticals, printable electronics inorganic and organic materials, lithium ion or other battery type electrolytes, nanomaterials (including for example, fullerenes, inorganic nanoparticles, sol-gels, and other ceramics), and radioactive chemicals; pesticides/fertilizers; paints/glosses/solvents/coating-materials etc.; adhesives; power washing fluids; lubricants for use in the automobile or aviation industry, for example; food products, such as but not limited to, condiments, cooking oils, and soft drinks, for example; reagents or other materials for use in the biomedical or research industry; hazardous materials used by the military, for example; polyurethanes; agrochemicals; industrial chemicals; cosmetic chemicals; petroleum and lubricants; sealants; health and oral hygiene products and toiletry products; or any other material that may be dispensed by pressure dispense, for example. Materials that may be used with embodiments of the present disclosure may have any viscosity, including high viscosity and low viscosity fluids. Those skilled in the art will recognize the benefits of the disclosed embodiments, and therefore will recognize the suitability of the disclosed embodiments to various industries and for the transportation and dispense of various products. In some embodiments, the disclosed embodiments may be particularly useful in industries relating to the manufacture of semiconductors, flat panel displays, LEDs, and solar panels; industries involving the application of adhesives and polyamides; industries utilizing photolithography technology; or any other critical material delivery application. However, the various embodiments disclosed herein may be used in any suitable industry or application.

After dispense is completed or substantially completed and the liner is empty or substantially empty, the end-user may dispose of the dip tube assembly and/or recycle some or all components of the dip tube assembly. In order to assist in making the dip tube assembly described herein more sustainable, the dip tube assembly or one or more components thereof, in some embodiments may be manufactured from biodegradable materials or biodegradable polymers, including but not limited to: polyhydroxyalkanoates (PHAs), like poly-3-hydroxybutyrate (PHB), polyhydroxyvalerate (PHV), and polyhydroxyhexanoate (PHH); polylactic acid (PLA); polybutylene succinate (PBS); polycaprolactone (PCL); polyanhydrides; polyvinyl alcohol; starch derivatives; cellulose esters, like cellulose acetate and nitrocellulose and their derivatives (celluloid); etc. Similarly, in some embodiments, and if suitable for the industry application, the dip tube assembly or one or more components thereof, may be manufactured from materials that can be recycled or recovered, and in some embodiments, used in another process by the same or a different end user, thereby allowing such end user(s) to lessen their impact on the environment or lower their overall emissions. For example, in one embodiment, the dip tube assembly or one or more components thereof may be manufactured from materials that may be incinerated, such that the heat generated therefrom may be captured and incorporated or used in another process by the same or different end user. In general the dip tube assembly or one or more components thereof may be manufactured from materials that can be recycled, or that may be converted into raw materials that may be used again.

In the foregoing description various embodiments of the invention have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

1. A dip tube assembly comprising:
a tubular body portion; and
a coupler overmolded to a first end of the tubular body portion, the coupler configured for removable coupling with the mouth of a container storing contents therein.

2. The dip tube assembly of claim 1, wherein at least one of the tubular body portion and coupler comprises retention features molded into a surface thereof at an overmold interface between the tubular body portion and the coupler.

3. The dip tube assembly of claim 2, wherein one of the tubular body portion and coupler comprises a groove molded into a surface thereof at the overmold interface and the other of the tubular body portion and coupler comprises a mating rib molded into a surface thereof at the overmold interface.

4.-12. (canceled)

13. A method of making a dip tube assembly, the method comprising:
overmolding a coupler to a first end of an elongated tubular body, the coupler configured for removable coupling with the mouth of a container storing contents therein with the tubular body portion extending into an interior of the container.

14. The method of claim 13, wherein at least one of the elongated tubular body and the coupler comprises retention features molded into a surface thereof at an overmold interface between the tubular body portion and the coupler.

15. A container assembly comprising:
a rigid overpack;
a collapsible liner provided within the overpack and having a fitment defining a mouth to the collapsible liner; and
a dip tube assembly, comprising:
a tubular body portion; and
a coupler overmolded to a first end of the tubular body portion, the coupler removably coupled with the fitment of the collapsible liner with the tubular body portion extending into an interior of the collapsible liner.

16. The container assembly of claim 15, wherein the coupler comprises a circumferential notch having an O-ring positioned therein for liquid-tight sealing with the fitment.

17. The container assembly of claim 16, wherein the coupler further comprises a notch permitting headspace gas removal.

18. The container assembly of claim 15, wherein at least one of the tubular body portion and coupler comprises retention features molded into a surface thereof at an overmold interface between the tubular body portion and the coupler.

19. (canceled).
